(19) United States
(12) Patent Application Publication
(10) Pub. No.: US 2020/0260136 A1
(43) Pub. Date: Aug. 13, 2020

(54) DEVICE CONTROL APPARATUS, DEVICE CONTROL METHOD, AND DEVICE CONTROL PROGRAM

(71) Applicant: Mitsubishi Electric Corporation, Tokyo (JP)

(72) Inventors: Masayuki KIRIMURA, Tokyo (JP); Daisuke NAKAMURA, Tokyo (JP)

(73) Assignee: Mitsubishi Electric Corporation, Tokyo (JP)

(21) Appl. No.: 16/649,331

(22) PCT Filed: Oct. 31, 2017
(86) PCT No.: PCT/JP2017/039362

§ 371 Date: Mar. 20, 2020

(51) Int. Cl. H04N 21/422; H04N 21/442

(52) U.S. Cl. CPC H04N 21/422; H04N 21/44231

(57) ABSTRACT

The following units are included: a signal acquiring unit (102) acquiring a device control signal that is transmitted from a device remote controller (200) and used to control a device (300); an extended function determining unit (103) acquiring a control program for executing an extended function that corresponds to the device control signal and is not supported by the device (300) by collating the device control signal acquired with accumulated information; and an output control unit (108) controlling a corresponding output apparatus (400) by executing the control program acquired.

### TECHNICAL FIELD

The present invention relates to a technique for receiving a signal output from a device and providing a function corresponding to the received signal.

### BACKGROUND ART

In recent years, it is desired to perform various controls without bothering users depending on usage statuses of various devices used by the users. For example, various techniques have been devised for receiving a signal output from a remote controller for operating a device and providing information obtained from the received signal to users, business operators, and the like.

A television (TV) viewing information survey apparatus described in Patent Literature 1 receives and analyzes a signal output from a common TV remote controller, and records measurement data on the basis of the analysis result. The measurement data includes start data recorded when viewing of a new channel program is started, and end data recorded when the power of the TV is turned off.

In addition, when a channel to be switched to is determined as a result of analyzing the signal output from the TV remote controller, the TV viewing information survey apparatus described in Patent Literature 1 provides information by which a viewer can confirm whether or not the TV viewing status survey apparatus correctly recognizes the signal output from the TV remote controller, by displaying a message including information regarding the determined channel on display means.

For example, when a viewer operates the TV remote controller with an intention of switching the TV channel, and the TV screen is switched to an intended channel program, but the remote controller signal does not reach the TV viewing status survey apparatus, the display means displays information of a channel different from the channel being viewed. With this display, the viewer can recognize that the TV viewing status survey apparatus does not make correct recognition.

### CITATION LIST

### Patent Literatures

Patent Literature 1: JP 2004-147036 A

### SUMMARY OF INVENTION

### Technical Problem

However, in the TV viewing information survey apparatus described in Patent Literature 1 mentioned above, the signal output from a common TV remote controller is used, and only state information indicating whether or not the signal of the TV remote controller reaches the TV viewing status survey apparatus is presented. That is, in the TV viewing information survey apparatus described in Patent Literature 1, there is a problem that it is not possible to present a function that is a new function not held by the TV and useful for users not simply a presentation of state information, in response to operation on a common TV remote controller.

The present invention has been made to solve the above-described problem, and it is an object to provide a function that is a new function not supported by a device in advance and useful for users, in response to operation on a common device remote controller, corresponding to the operation of the device remote controller.

### Solution to Problem

A device control apparatus according to the present invention includes: a signal acquiring unit acquiring a device control signal that is transmitted from a device remote controller and used to control a device; an extended function determining unit acquiring a control program for executing an extended function that corresponds to the device control signal and is not supported by the device by collating the device control signal acquired by the signal acquiring unit with accumulated information; and an output control unit controlling a corresponding output apparatus by executing the control program acquired by the extended function determining unit.

### Advantageous Effects of Invention

According to the present invention, using a common device remote controller, it is possible to provide a function that is a new function not supported by a device and useful for users, corresponding to operation of the device remote controller.

### BRIEF DESCRIPTION OF DRAWINGS

FIG. 1 is a diagram illustrating a configuration of a device system including a device control apparatus according to a first embodiment.

FIG. 2 is a block diagram illustrating a configuration of the device control apparatus according to the first embodiment.

FIG. 3 is a diagram illustrating an example of stored data in a device control signal database of the device control apparatus according to the first embodiment.

FIG. 4 is a diagram illustrating an example of stored data in an extended function database of the device control apparatus according to the first embodiment.

FIGS. 5A and 5B are diagrams illustrating a hardware configuration example of the device control apparatus according to the first embodiment.

FIG. 6 is a flowchart illustrating operation of the device control apparatus according to the first embodiment.

FIG. 7 is a sequence diagram illustrating processing operation of the device system including the device control apparatus according to the first embodiment.

FIG. 8 is a diagram illustrating a processing example of the device system including the device control apparatus according to the first embodiment.

FIG. 9 is a diagram illustrating a configuration of a device system including a device control apparatus according to a second embodiment.

FIG. 10 is a block diagram illustrating a configuration of the device control apparatus according to the second embodiment.

FIG. 11 is a flowchart illustrating operation of the device control apparatus according to the second embodiment.

FIG. 12 is a sequence diagram illustrating processing operation of the device system including the device control apparatus according to the second embodiment.

FIG. 13 is a diagram illustrating a processing example of the device system including the device control apparatus according to the second embodiment.

### DESCRIPTION OF EMBODIMENTS

Hereinafter, to explain the present invention in more detail, some embodiments for carrying out the present invention will be described with reference to the accompanying drawings.

### First Embodiment

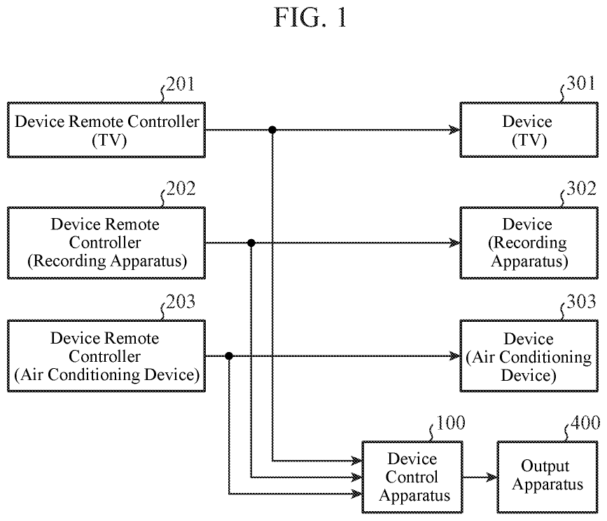

FIG. 1 is a diagram illustrating a configuration of a device system including a device control apparatus 100 according to a first embodiment.

The device system includes: the device control apparatus 100; a device remote controller 201 for controlling a TV, a device remote controller 202 for controlling a recording apparatus, and a device remote controller 203 for controlling an air conditioning device (hereinafter, these remote controllers are collectively referred to as a device remote controller 200); a device 301 that is the TV, a device 302 that is the recording apparatus, and a device 303 that is the air conditioning device (hereinafter, these devices are collectively referred to as a device 300); and an output apparatus 400.

The device remote controller 200 is connected for communication with the device 300 by, for example, infrared communication, radio frequency communication in accordance with the Wi-Fi (which is a registered trademark, and the notation that it is a registered trademark is omitted in the following) (wireless LAN) standard such as EchonetLite (which is a registered trademark, and the notation is omitted in the following), short-range wireless communication such as Bluetooth (a registered trademark, and the notation is omitted in the following) or Zigbee (a registered trademark, and the notation is omitted in the following), or wired connection. The device remote controller 200 transmits a device control signal to the device 300 by using the communication connection described above.

The device control apparatus 100 intercepts the device control signal transmitted from the device remote controller 200, and performs control for executing a new function (hereinafter referred to as an extended function) not supported by the device 300 in advance, on the basis of the intercepted device control signal. The device control apparatus 100 controls the output apparatus 400 by executing a control program for executing the extended function. A detailed configuration of the device control apparatus 100 will be described later. The output apparatus 400 includes an output device, for example, a display, a speaker, a pilot lamp light emitting apparatus, or the like.

The device control apparatus 100 may or may not be able to communicate with the device 300. When the device control apparatus 100 is able to communicate with the device 300, the connection means may be wired or wireless. In addition, the device control apparatus 100 may be connected to the device 300 to receive only power supply, or may be mounted as a circuit in the same device 300. For the output apparatus 400, an output device may be used such as a display, a speaker, or a light emitting apparatus other than the device 300, or an output device may be used such as a display, a speaker, or a light emitting apparatus of the device 300.

In addition, FIG. 1 illustrates a case where device control signals are input from the three device remote controllers 201, 202, and 203 to the device control apparatus 100, but the number of device control signals is not limited to this. For example, the device control apparatus 100 may be configured to perform control corresponding to a device control signal input from only one device remote controller 200.

Next, details of the device control apparatus 100 will be described.

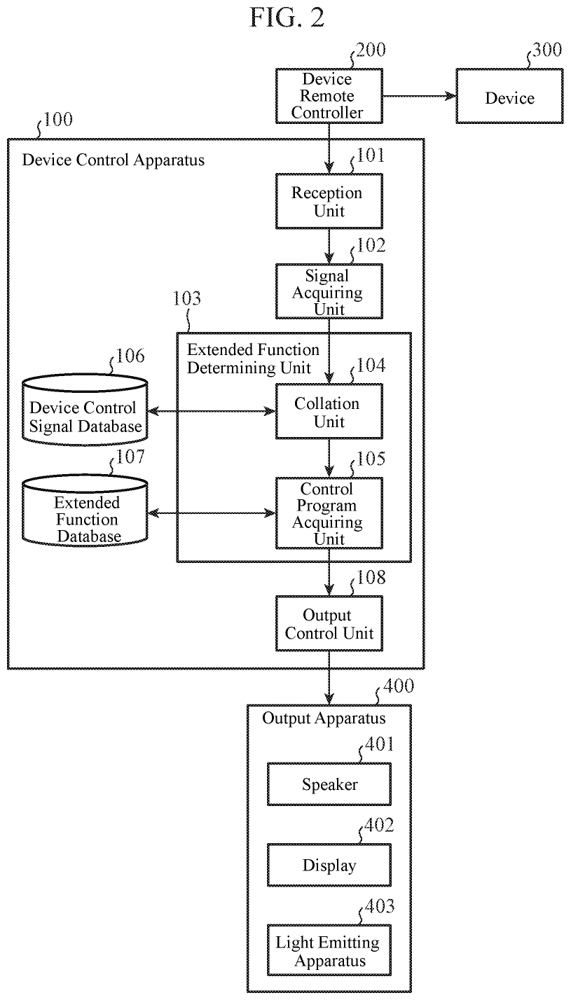

FIG. 2 is a block diagram illustrating a configuration of the device control apparatus 100 according to the first embodiment.

The device control apparatus 100 includes a reception unit 101, a signal acquiring unit 102, an extended function determining unit 103, a device control signal database 106, an extended function database 107, and an output control unit 108. The extended function determining unit 103 includes a collation unit 104 and a control program acquiring unit 105.

The device control apparatus 100 and the device remote controller 200 are connected for communication with each other by, for example, infrared communication, radio frequency communication in accordance with the Wi-Fi (wireless LAN) standard such as EchonetLite, short-range wireless communication such as Bluetooth or Zigbee, or the like. The device control apparatus 100 and the output apparatus 400 may be connected to each other by wired or wireless communication, or may be mounted as circuits in the same device.

The reception unit 101 receives a device control signal transmitted from the device remote controller 200, and outputs the device control signal to the signal acquiring unit 102. The signal acquiring unit 102 outputs the input device control signal to the collation unit 104 of the extended function determining unit 103. The collation unit 104 collates the input device control signal with the device control signal database 106, and acquires program identification information associated with the device control signal. Here, the program identification information is information assigned to each control program to uniquely identify each of a plurality of control programs for executing various extended functions. The collation unit 104 outputs the program identification information to the control program acquiring unit 105, as a collation result. The device control signal database 106 stores the device control signal and the program identification information in association with each other. Details of the device control signal database 106 will be described later.

The control program acquiring unit 105 refers to the extended function database 107 and acquires a control program corresponding to the input program identification information. The control program acquiring unit 105 outputs the acquired control program to the output control unit 108. The extended function database 107 stores the program identification information and the control program in association with each other. Details of the extended function database 107 will be described later. The output control unit 108 controls the corresponding output apparatus 400 by executing the input control program.

Note that, FIG. 1 illustrates a configuration in which the device control apparatus 100 includes the device control signal database 106 and the extended function database 107; however, the device control signal database 106 and the extended function database 107 may be included in a device other than the device control apparatus 100.

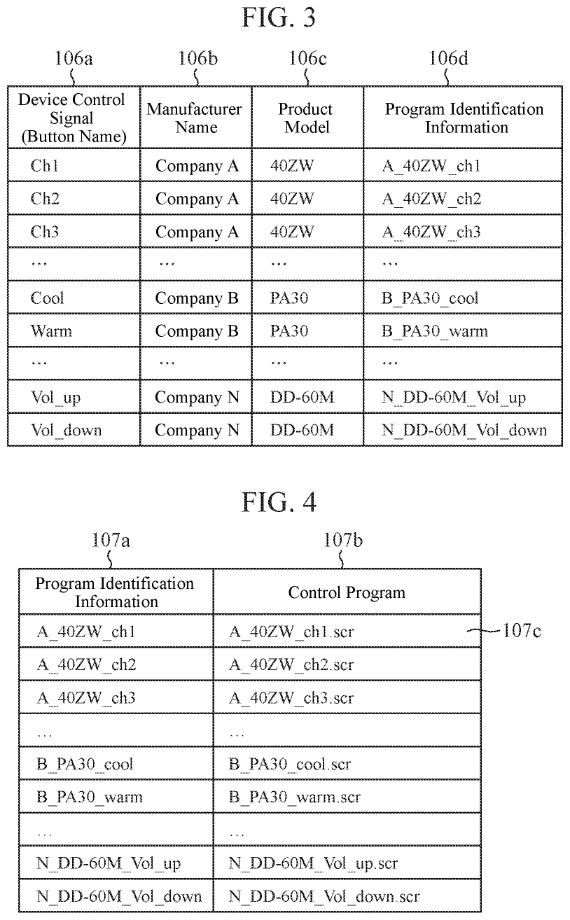

FIG. 3 is a diagram illustrating an example of stored data in the device control signal database 106 of the device control apparatus 100 according to the first embodiment.

The device control signal database 106 stores information 106a indicating a device control signal, information 106b indicating a manufacturer name, information 106c indicating a product model, and program identification information 106d in association with each other.

When a device control signal “Ch1” is input, for example, the collation unit 104 refers to the device control signal database 106 illustrated in FIG. 3, thereby acquiring information indicating that the device 300 to be controlled by the device control signal is a product model “40ZW” of a manufacturer name “company A”. In addition, the collation unit 104 acquires information indicating that the program identification information of the control program for controlling the device 300 is “A_40ZW_ch1”.

In the device control signal database 106 illustrated in FIG. 3, the database may be configured by further associating the data with at least one of time of day information or date information (information of time).

The collation unit 104 refers to the device control signal database 106 configured by associating data with at least one of the time of day information or the date information, thereby being able to acquire the program identification information corresponding to the time of day information when an pressing operation is performed on the device remote controller 200 or the program identification information corresponding to the season. As a result, for example, in summer, when the button “power ON” of the device remote controller 200 of the device (air conditioning device) 303 is pressed, the output control unit 108 of the device control apparatus 100 executes a control program for outputting sound notifying the output apparatus 400 that switching to cooling operation is to be performed, and outputs a device control signal for performing switching to the cooling operation to the device 303.

As in the example described above, the output control unit 108 of the device control apparatus 100 is not limited to the configuration for outputting the device control signal to the output apparatus 400, and may be configured to output the device control signal to the device 300.

FIG. 4 is a diagram illustrating an example of stored data in the extended function database 107 of the device control apparatus 100 according to the first embodiment.

The extended function database 107 stores program identification information 107a and a control program 107b in association with each other. When the program identification information “A_40ZW_ch1” is input, for example, the control program acquiring unit 105 refers to the extended function database 107 illustrated in FIG. 4, thereby acquiring a control program 107c “A_40ZW_ch1.scr” specified by program identification information “A_40ZW_ch1”.

Specific examples of the program identification information of the device control signal database 106, and the control program of the extended function database 107 will be described.

For example, the device control signal database 106 and the extended function database 107 store program identification information and a control program for displaying an icon of “∘∘ broadcast station” corresponding to “Ch4” on the display of the output apparatus 400 when a button “Ch4” of the device remote controller 200 is pressed.

In addition, for example, the device control signal database 106 and the extended function database 107 store program identification information and a control program for displaying a scoreboard on the display of the output apparatus 400 when the button “Ch4” of the device remote controller 200 is pressed and a baseball game is broadcast on the channel Ch4.

In addition, for example, the device control signal database 106 and the extended function database 107 store program identification information and a control program for acquiring program information from an Electronic Program Guide (EPG) and displaying program information of “∘∘ broadcast station” on the output apparatus 400 when the button “Ch4” of the device remote controller 200 is pressed. In addition, for example, the device control signal database 106 and the extended function database 107 store program identification information and a control program for outputting a control signal for ending the operation of the device 300 at the program end time from the acquired program information.

Next, a hardware configuration example of the device control apparatus 100 will be described.

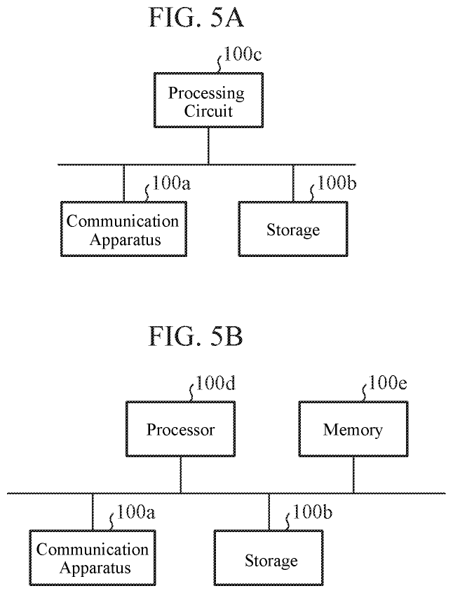

FIGS. 5A and 5B are diagrams illustrating a hardware configuration example of the device control apparatus 100 according to the first embodiment.

The reception unit 101 in the device control apparatus 100 is a communication apparatus 100a for performing wireless communication or wired communication with the device remote controller 200. The device control signal database 106 and the extended function database 107 in the device control apparatus 100 are implemented by a storage 100b. Functions of the signal acquiring unit 102, the collation unit 104, the control program acquiring unit 105, and the output control unit 108 in the device control apparatus 100 are implemented by a processing circuit. That is, the device control apparatus 100 includes a processing circuit for implementing the functions described above. The processing circuit may be a processing circuit 100c that is dedicated hardware as illustrated in FIG. 5A, or a processor 100d for executing a program stored in a memory 100e as illustrated in FIG. 5B.

As illustrated in FIG. 5A, when the signal acquiring unit 102, the collation unit 104, the control program acquiring unit 105, and the output control unit 108 each are dedicated hardware, examples of the processing circuit 100c include a single circuit, a composite circuit, a programmed processor, a parallel-programmed processor, an application specific integrated circuit (ASIC), a field-programmable gate array (FPGA), or a combination thereof. The functions of the signal acquiring unit 102, the collation unit 104, the control program acquiring unit 105, and the output control unit 108 may be implemented by respective processing circuits, or the functions of the units may be collectively implemented by a single processing circuit.

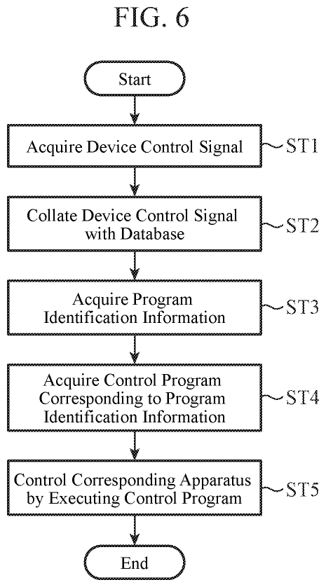

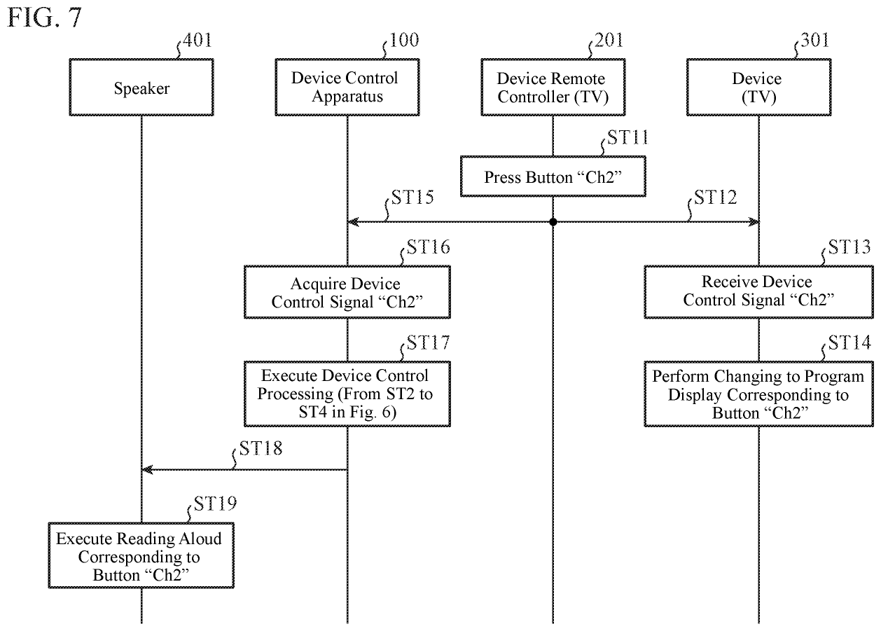

As illustrated in FIG. 5B, when the signal acquiring unit 102, the collation unit 104, the control program acquiring unit 105, and the output control unit 108 each are the processor 100d, the functions of the units are implemented by software, firmware, or a combination of software and firmware. The software or the firmware is described as a program and stored in the memory 100e. The processor 100d reads and executes the program stored in the memory 100e, thereby implementing the functions of the signal acquiring unit 102, the collation unit 104, the control program acquiring unit 105, and the output control unit 108. That is, the signal acquiring unit 102, the collation unit 104, the control program acquiring unit 105, and the output control unit 108 include the memory 100e for storing a program by which each step illustrated in FIG. 6 described later is resultantly executed when executed by the processor 100d. In addition, it can also be said that these programs cause a computer to execute procedures or methods of the signal acquiring unit 102, the collation unit 104, the control program acquiring unit 105, and the output control unit 108.

Here, the processor 100d is, for example, a central processing unit (CPU), a processing device, an arithmetic device, a processor, a microprocessor, a microcomputer, a digital signal processor (DSP), or the like.

For example, the memory 100e may be a nonvolatile or volatile semiconductor memory such as a random access memory (RAM), a read only memory (ROM), a flash memory, an erasable programmable ROM (EPROM), or an electrically EPROM (EEPROM), may be a magnetic disk such as a hard disk or a flexible disk, or may be an optical disc such as a mini disc, a compact disc (CD), or a digital versatile disc (DVD).

Note that, a part of the functions of the signal acquiring unit 102, the collation unit 104, the control program acquiring unit 105, and the output control unit 108 may be implemented by dedicated hardware and the other part thereof may be implemented by software or firmware. As described above, the processing circuit in the device control apparatus 100 can implement the above-described functions by hardware, software, firmware, or a combination thereof.

Next, operation of the device control apparatus 100 will be described.

FIG. 6 is a flowchart illustrating the operation of the device control apparatus 100 according to the first embodiment.

When the signal acquiring unit 102 acquires a device control signal transmitted from the device remote controller 200 via the reception unit 101 (step ST1), the signal acquiring unit 102 outputs the acquired device control signal to the collation unit 104. The collation unit 104 collates the input device control signal with the device control signal database 106 (step ST2). The collation unit 104 acquires program identification information as the collation result in step ST2 (step ST3). The collation unit 104 outputs the program identification information acquired in step ST3 to the control program acquiring unit 105.

The control program acquiring unit 105 refers to the extended function database 107 and acquires a control program corresponding to the input program identification information (step ST4). The control program acquiring unit 105 outputs the control program acquired in step ST4 to the output control unit 108. The output control unit 108 executes the input control program, controls the corresponding output apparatus 400 (step ST5), and ends the processing.

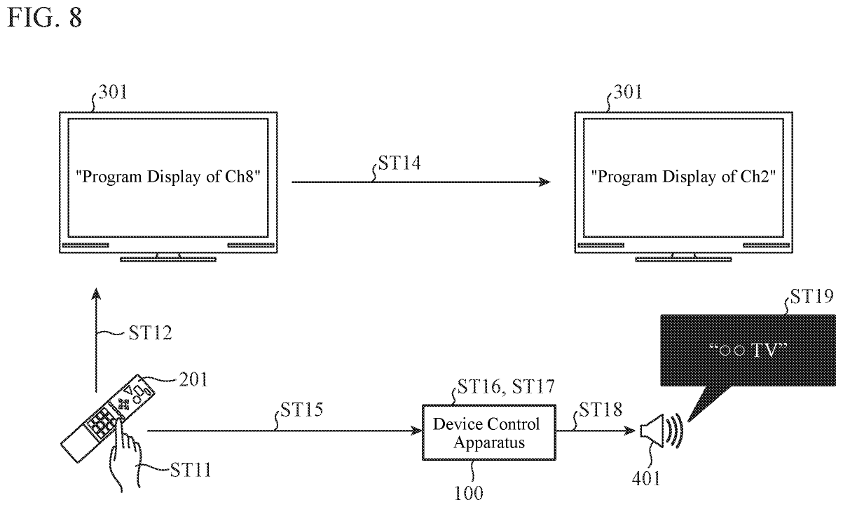

Next, with reference to FIGS. 7 and 8, processing operation of the entire device system when a device control signal is output from the device remote controller 200 will be described.

FIG. 7 is a sequence diagram illustrating processing operation of the device system including the device control apparatus 100 according to the first embodiment.

FIG. 8 is a diagram illustrating a processing example of the device system including the device control apparatus 100 according to the first embodiment.

FIGS. 7 and 8 illustrate an example case where the device (TV) 301 is controlled by using the device remote controller 201 of the TV. It is assumed that programs of “Ch8” are displayed on the device 301 before the processing is performed.

First, when a button of the device remote controller 201, for example, “Ch2” is pressed (step ST11), the device remote controller 201 transmits a device control signal “Ch2” corresponding to the button “Ch2” to the device 301 (step ST12), and outputs the device control signal “Ch2” to the device control apparatus 100 (step ST15). The device 301 receives the device control signal “Ch2” transmitted in step ST12 (step ST13). The device 301 changes the program display of “Ch8” to a program display of “Ch2” on the basis of the device control signal received in step ST13 (step ST14).

On the other hand, the signal acquiring unit 102 of the device control apparatus 100 acquires the device control signal “Ch2” transmitted in step ST15 (step ST16). Note that, the processing in step ST16 is the same as the processing in step ST1 in the flowchart of FIG. 6. The device control apparatus 100 executes the processing from step ST2 to step ST4 in the flowchart of FIG. 6 and acquires a control program corresponding to the device control signal “Ch2” (step ST17). Here, a description will be made assuming that a program for executing reading aloud of information corresponding to the button is acquired as a control program according to the device control signal “Ch2”.

The output control unit 108 of the device control apparatus 100 controls the speaker 401 of the output apparatus 400 by executing the program for executing reading aloud acquired in step ST17 (step ST18). Note that, the processing in step ST18 is the same as the processing in step ST5 in the flowchart of FIG. 6. Specifically, in step ST18, the output control unit 108 controls the speaker 401 by executing a control program for performing sound output of “∘∘ TV” as the control program for executing reading aloud corresponding to the button “Ch2”. The speaker 401 executes reading aloud corresponding to the button “Ch2” on the basis of the control program output in step ST18, that is, performs sound output of “∘∘ TV” (step ST19).

Through the above processing operation, the user presses “Ch2” of the device remote controller 201, whereby change of the program display in the device 301 is performed that is a function supported by the device 301 in advance. Further, the device control apparatus 100 executes control for performing reading aloud corresponding to the pressed button “Ch2”, for example, sound output of “∘∘ TV” that is a function not supported by the device 301 in advance. That is, in the device system, only by performing the same operation as the conventional operation on the device remote controller 201, the user can cause a function supported by the device 301 in advance to be executed, and further cause a new function not supported by the device 301 in advance, that is, an extended function to be executed.

Examples of the new function supported by the device 301 in advance include the following functions.

For example, when the device control apparatus 100 receives a device control signal due to pressing of a button “3D” from the device remote controller 200 of the device 301, the collation unit 104 acquires program identification information associated with a device control signal “3D”. The control program acquiring unit 105 acquires a control program corresponding to the program identification information, for example, a control program for switching the channel of the device 301 in a short time to Ch1, Ch2, Ch3, . . . . On the basis of the control program for switching the displays in a short time, to perform channel switching in order of Ch1, Ch2, Ch3, . . . , the output control unit 108 controls the output apparatus 400 by sequentially executing, for the device 301, a control program for switching to Ch1, a control program for switching to Ch2, and a control program for switching to Ch3.

As described above, the device control apparatus 100 may be configured to execute a plurality of control programs for new functions not supported by the device 301 in advance by pressing one button.

In addition, for example, when the device control apparatus 100 receives a device control signal due to pressing of a button “input switching” from the device remote controller 200 of the device 301, the collation unit 104 acquires program identification information associated with a device control signal “input switching”. The control program acquiring unit 105 acquires a control program corresponding to the program identification information, for example, a control program for gradually increasing the volume of the device 301. On the basis of the control program for gradually increasing the volume, the output control unit 108 sequentially executes, for the device 301, a plurality of control programs for gradually increasing the volume.

As a result, at the same time when the button “input switching” is pressed and the input source of the signal to the display of the device 301 is switched from the TV to the recording apparatus, the device control apparatus 100 can adjust a change in volume such as a change to larger volume or smaller volume of the sound output from the speaker of the device 301.

In addition, for example, when the device control apparatus 100 receives a device control signal due to pressing of a specific button from the device remote controller 200 of the device 301, the collation unit 104 acquires a control program associated with the specific button, and as a result, a configuration can be made in which program identification information in accordance with user's preference is acquired.

For example, in a case where a timer shut-off function supported by the device 300 in advance is set in units of one hour, the device control apparatus 100 can acquire a control program for implementing the timer shut-off function in units of a time adapted to the user's preference (for example, in units of 12 minutes). In this case, the control program is configured as follows: when a device control signal due to pressing of a specific button is input, a timer which is internally held (not illustrated) starts counting, and when the set 12 minutes is elapsed, a shut-off signal is output to the device 300. As a result, the device control apparatus 100 can easily implement a timer shut-off function in accordance with the user's preference. In addition, the device control apparatus 100 can easily implement a function of turning off power of the TV when, for example, a currently viewed program ends with reference to EPG information of the TV.

In addition, the device control signal database 106 is made to store program identification information corresponding to various devices 300, whereby it becomes possible to control any device 300 by using the device remote controller 200. As a result, when the device remote controller 200 of a certain device 300 breaks down, the device remote controller 200 of another device 300 can be used as the device remote controller 200 of the certain device 300.

As described above, the device control apparatus 100 according to the first embodiment includes: the signal acquiring unit 102 acquiring the device control signal that is transmitted from the device remote controller 200 and used to control the device 300; the extended function determining unit 103 acquiring the control program for executing the extended function that corresponds to the device control signal and is not supported by the device 300 by collating the device control signal acquired with accumulated information; and the output control unit 108 controlling the corresponding output apparatus by executing the control program acquired.

As a result, using a common device remote controller, it is possible to provide a function that is a new function not supported by a device and useful for users, corresponding to operation of the device remote controller. In addition, it is possible to provide an extended function different from functions supported by the device 300 in advance without hindering operation of the device remote controller 200 for the device 300. In addition, it is possible to provide the extended function without modifying the device remote controller 200 and the device 300, and the cost can be reduced.

In addition, since it is possible to provide an extended function without preparing a new device remote controller 200, the user does not need time and effort such as learning of operation of the new device remote controller 200, and the extended function can be easily executed.

In addition, since it is possible to execute an extended function only by performing operation similar to a conventional operation, the user can feel that the function of the device 300 is improved without performing work such as updating the device remote controller 200 and the device 300.

A configuration for acquiring detection information that is information detected by a sensor apparatus (not illustrated) may be added to the device control apparatus 100 of the first embodiment described above. In that case, in the device control signal database 106, the detection information is stored in association with the other stored data. The collation unit 104 acquires program identification information corresponding to the detection information by referring to the device control signal database 106 in which data is stored in association with the detection information.

As a result, for example, when the button “power ON” of the device remote controller 200 of the device (air conditioning device) 303 is pressed and the detection information at that time indicates a room temperature of greater than or equal to 35 degrees, the device control apparatus 100 can control the device 303 by executing a control program for the cooling operation and high power operation.

Similarly, using the detection information acquired from the sensor apparatus, the device control apparatus 100 can be configured as follows.

When the button “power ON” of the device remote controller 200 is pressed and the detection information at that time indicates that noise greater than or equal to a threshold value is generated around the device 300, the device control apparatus 100 outputs, to the device 300, a control program for increasing the output volume of the device 300.

In addition, when the button “power ON” of the device remote controller 200 is pressed and the detection information at that time indicates that the brightness around the device 300 is less than or equal to a threshold value, the device control apparatus 100 controls the device 300 by executing a control program for reducing the luminance of the backlight of the device 300.

In addition, when the button “power ON” of the device remote controller 200 is pressed and the detection information at that time indicates that a shake greater than or equal to a threshold value is detected, the device control apparatus 100 controls the device 300 by executing a control program for changing a channel number of the device 300 to a preset number.

### Second Embodiment

In this second embodiment, a configuration will be described in which information acquired from a sensor apparatus or the like is transmitted to an external apparatus when the device remote controller 200 is pressed, in addition to the processing described in the first embodiment.

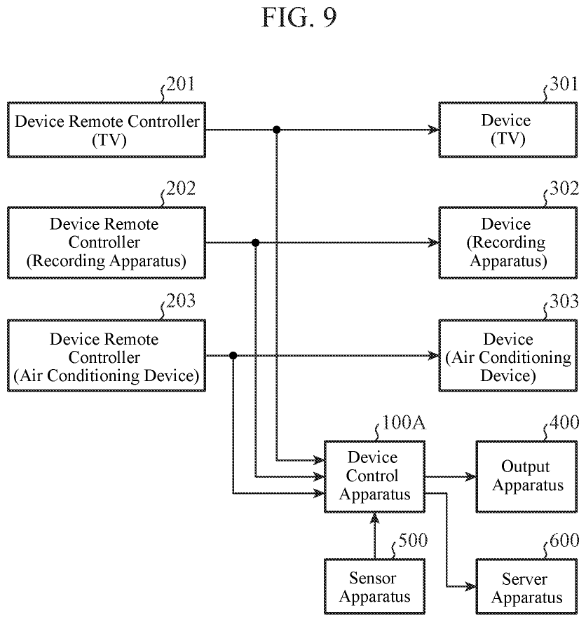

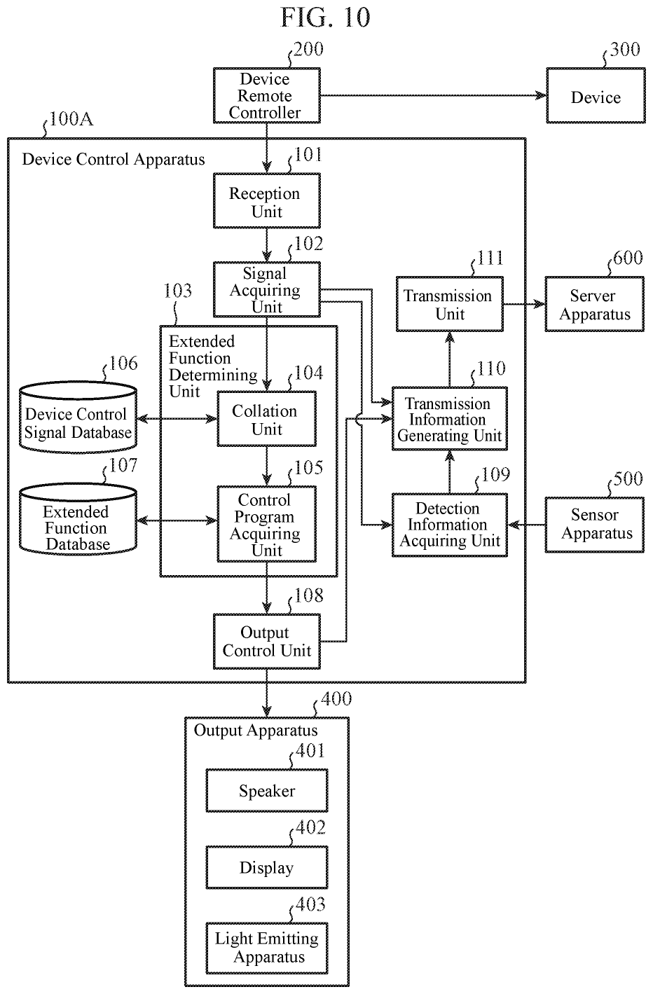

FIG. 9 is a diagram illustrating a configuration of a device system including a device control apparatus 100 according to the second embodiment.

The device system of the second embodiment is configured by adding a sensor apparatus 500 and a server apparatus 600 to the device system illustrated in FIG. 1. Hereinafter, the same components or corresponding portions as those of the device system according to the first embodiment are denoted by the same reference numerals as those used in the first embodiment, and the description thereof will be omitted or simplified.

Similarly to the first embodiment, the device control apparatus 100A performs control for executing a new function not supported by the device 300 in advance, on the basis of a device control signal output from the device remote controller 200. Further, the device control apparatus 100A performs control to acquire detection information detected by the sensor apparatus 500 and transmit the detection information to the server apparatus 600 on the basis of the device control signal output from the device remote controller 200.

FIG. 10 is a block diagram illustrating a configuration of the device control apparatus 100A according to the second embodiment.

The device control apparatus 100A according to the second embodiment is configured by adding a detection information acquiring unit 109, a transmission information generating unit 110, and a transmission unit 111 to the device control apparatus 100 illustrated in FIG. 2. Hereinafter, the same components or corresponding portions as those of the device control apparatus 100 according to the first embodiment are denoted by the same reference numerals as those used in the first embodiment, and the description thereof will be omitted or simplified.

When the device control signal is input from the reception unit 101, the signal acquiring unit 102 outputs the input device control signal to the collation unit 104, and also to the detection information acquiring unit 109 and the transmission information generating unit 110. When outputting the device control signal to the transmission information generating unit 110, the signal acquiring unit 102 adds the time of day at which the device control signal is acquired and performs outputting.

When the device control signal is input from the signal acquiring unit 102, the detection information acquiring unit 109 acquires detection information from the sensor apparatus 500. The detection information acquiring unit 109 outputs the acquired detection information to the transmission information generating unit 110. The sensor apparatus 500 is, for example, a temperature sensor, a humidity sensor, a biological sensor, an acceleration sensor, a human sensor, an illuminance sensor, a distance measurement sensor, a camera, and a microphone. When the sensor apparatus 500 includes a temperature sensor, the detection information acquiring unit 109 acquires information indicating the current room temperature detected by the temperature sensor as the detection information. When the sensor apparatus 500 includes, for example, a biological sensor, the detection information acquiring unit 109 acquires information indicating the body temperature and pulse of a person to be detected that is detected by the biological sensor, as the detection information.

The output control unit 108 executes the transmission information generating unit 110 by executing a control program, in addition to the processing described in the first embodiment. The transmission information generating unit 110 generates transmission information to be transmitted to the server apparatus 600 on the basis of the device control signal input from the signal acquiring unit 102 and the detection information input from the detection information acquiring unit 109.

For example, the transmission information generating unit 110 generates information based on the device control signal input from the signal acquiring unit 102, for example, information “a button “1” of a device ∘∘ was pressed at hh:mm:ss”. The transmission information generating unit 110 refers to a database (not illustrated), and generates information related to the device control signal “1”, for example, information “∘∘ broadcast station”. On the basis of the control program executed by the output control unit 108, the transmission information generating unit 110 acquires an execution result of the extended function, for example, information “sound output of “∘∘ broadcast station””. The transmission information generating unit 110 generates detection information input from the detection information acquiring unit 109, for example, information “the room temperature when the device remote controller is pressed is ∘ degrees”.

The transmission information generating unit 110 generates transmission information by combining the information based on the device control signal, the information related to the device control signal, the execution result of the extended function, and the detection information which are described above. The transmission information generating unit 110 does not have to use all the information described above as transmission information. For example, the transmission information generating unit 110 can use appropriate combination, for example, use the information on the basis of the device control signal and the execution result of the extended function as transmission information, use only the execution result of the extended function as transmission information, use only information on the basis of the detection information as transmission information, or the like.

The transmission information generating unit 110 outputs the generated transmission information to the transmission unit 111. The transmission unit 111 transmits the transmission information input from the transmission information generating unit 110 to the server apparatus 600. The transmission unit 111 is connected for communication with the server apparatus 600 by infrared communication, radio frequency communication, short-range wireless communication, or the like.

The server apparatus 600 receives the transmission information transmitted from the transmission unit 111. The server apparatus 600 analyzes the received transmission information and performs processing such as distributing the analysis result. It is possible to appropriately set what processing the server apparatus 600 performs using the transmission information.

Next, a hardware configuration example of the device control apparatus 100A will be described. Note that, description of the same configuration as that of the first embodiment will be omitted.

The transmission unit 111 in the device control apparatus 100A is implemented by the communication apparatus 100a illustrated in FIG. 5A. In addition, the detection information acquiring unit 109 and the transmission information generating unit 110 in the device control apparatus 100A each are the processing circuit 100c illustrated in FIG. 5A, or the processor 100d for executing the program stored in the memory 100e illustrated in FIG. 5B.

Next, operation of the device control apparatus 100A will be described.

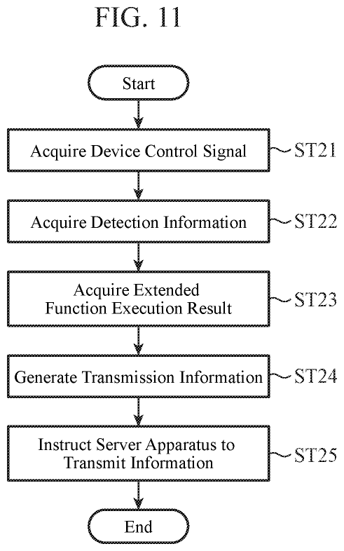

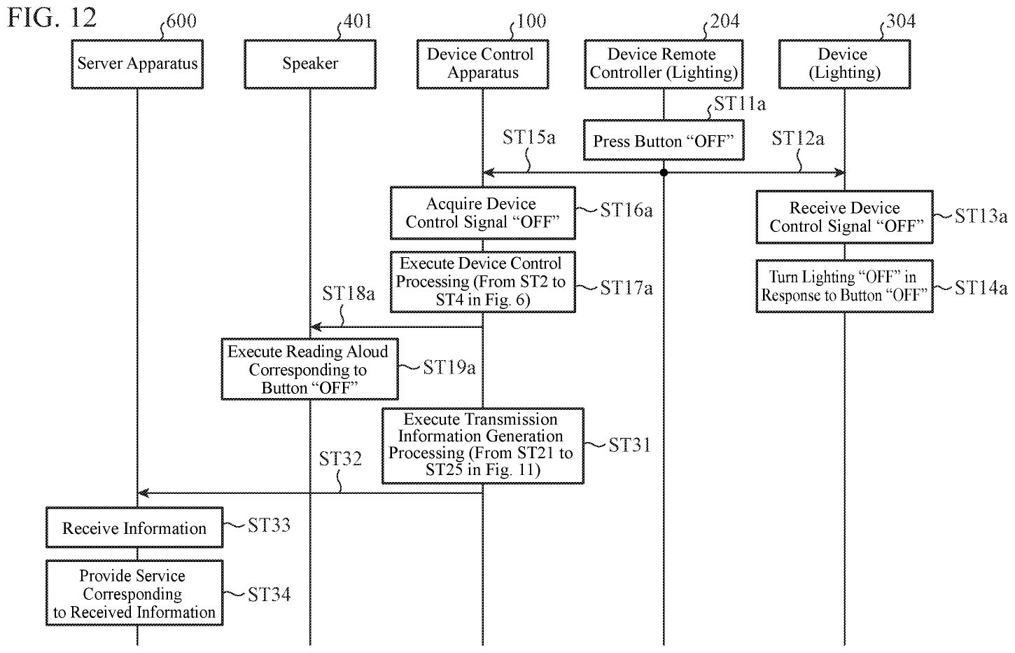

FIG. 11 is a flowchart illustrating information transmission processing operation of the device control apparatus 100A according to the second embodiment.

When the signal acquiring unit 102 acquires a device control signal transmitted from the device remote controller 200 via the reception unit 101 (step ST21), the signal acquiring unit 102 outputs the acquired device control signal to the collation unit 104, the detection information acquiring unit 109, and the transmission information generating unit 110. The collation unit 104, the control program acquiring unit 105, and the output control unit 108 perform the processing from step ST2 to step ST5 in the flowchart of FIG. 6 on the input device control signal. On the other hand, when the device control signal is input, the detection information acquiring unit 109 acquires detection information from the sensor apparatus 500 (step ST22). The detection information acquiring unit 109 outputs the acquired detection information to the transmission information generating unit 110.

When the device control signal is input, the transmission information generating unit 110 acquires an execution result of the extended function from the control program executed by the output control unit 108 (step ST23). The transmission information generating unit 110 generates transmission information on the basis of the device control signal input from the signal acquiring unit 102, the detection information input from the detection information acquiring unit 109, and the execution result of the extended function acquired in step ST23 (Step ST24). The transmission information generating unit 110 instructs the transmission unit 111 to transmit the transmission information generated in step ST24 to the server apparatus 600 (step ST25), and ends the processing.

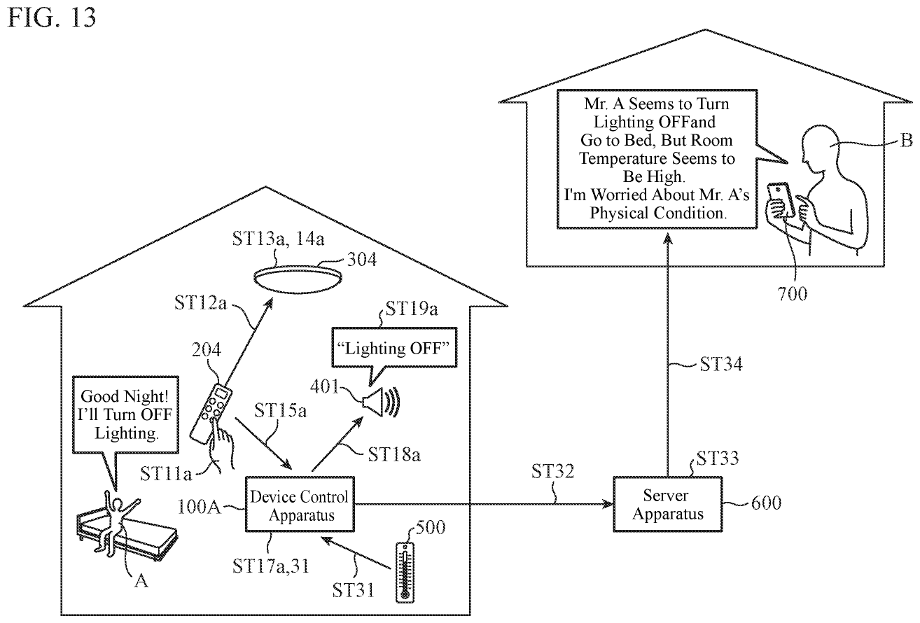

Next, with reference to FIGS. 12 and 13, information transmission processing operation of the entire device system when the device control signal is output from the device remote controller 200 will be described.

FIG. 12 is a sequence diagram illustrating the processing operation of the device system including the device control apparatus 100A according to the second embodiment.

FIG. 13 is a diagram illustrating a processing example of the device system including the device control apparatus 100A according to the second embodiment.

In FIGS. 12 and 13, an example case is illustrated where a first user A controls a device (lighting) 304 that is a lighting by using a device remote controller 204 for controlling the lighting, and information corresponding to the control is provided to a second user B. It is assumed that the lighting is in an ON state, in the device 304 before the processing is performed.

First, when the first user A presses a button of the device remote controller 204, for example, “OFF” (step ST11a), the device remote controller 204 transmits a device control signal “OFF” to the device 301 (step ST12a), and outputs the device control signal “OFF” to the device control apparatus 100 (step ST15a). The device 304 receives the device control signal “OFF” transmitted in step ST12a (step ST13a). The device 304 turns the lighting “OFF” on the basis of the device control signal “OFF” received in step ST13a (step ST14a).

On the other hand, the signal acquiring unit 102 of the device control apparatus 100A acquires the device control signal “OFF” transmitted in step ST15a (step ST16a). Note that, the processing in step ST16a is the same as the processing in step ST1 in the flowchart of FIG. 6. The device control apparatus 100A executes the processing from step ST2 to step ST4 in the flowchart of FIG. 6, and acquires a control program corresponding to the device control signal of the button “OFF” (step ST17a). Here, a description will be made assuming that a program for executing reading aloud is acquired as the control program corresponding to the device control signal “OFF”.

The output control unit 108 of the device control apparatus 100A controls the speaker 401 of the output apparatus 400 by executing the program for executing reading aloud acquired in step ST17a (step ST18a). Note that, the processing in step ST18a is the same as the processing in step ST5 in the flowchart of FIG. 6. Specifically, in step ST18a, the output control unit 108 controls the speaker 401 by executing the control program for executing reading aloud corresponding to the device control signal “OFF”, that is, a control program for performing sound output of “lighting OFF”. The speaker 401 executes reading aloud corresponding to the button “OFF” on the basis of the control program output in step ST18a, that is, performs sound output of “lighting OFF” (step ST19a).

Further, the device control apparatus 100A generates transmission information by executing the processing from step ST21 to step ST25 in the flowchart of FIG. 11, and instructs the transmission unit to transmit the generated transmission information (step ST31). Here, a description will be made assuming that, as the transmission information corresponding to the device control signal “OFF”, information is generated including information “the button “OFF” of the device remote controller of the lighting was pressed at 22:30:24”, an execution result of an extended function of “sound output of “lighting OFF””, and detection information “the room temperature is 32° C.”.

The transmission unit 111 of the device control apparatus 100A transmits the transmission information generated in step ST31 to the server apparatus 600 (step ST32). Specifically, the transmission unit 111 transmits, to the server apparatus 600, the information “the button “OFF” of the device remote controller of the lighting was pressed at 22:30:24”, the execution result of the extended function of “sound output of “lighting OFF””, and the information “the room temperature is 32° C.”, as the transmission information. When the server apparatus 600 receives the transmission information (step ST33), the server apparatus 600 provides a service such as transmitting the received transmission information to a device 700 held by the second user B (step ST34).

Through the above processing operation, first, the first user A presses “OFF” of the device remote controller 204, whereby the operation of turning off is performed that is a function supported by the device 304 in advance, and further, reading aloud corresponding to the pressed button “OFF”, for example, sound output of “lighting OFF” is performed that is a function not supported by the device 304 in advance. That is, only by performing the same operation as a conventional operation on the device remote controller 204, the user can cause a function supported by the device 304 in advance to be executed, and further cause a function not supported by the device 304 in advance, that is, an extended function to be executed. Further, in the example of FIG. 12, the server apparatus 600 transmits the transmission information transmitted from the device control apparatus 100A to the device 700 held by the second user B, whereby information regarding the first user A can be provided to the second user B. The second user B can grasp behavior of the first user A with reference to the information regarding the first user A. Further, the second user B recognizes from the behavior of the first user A that “Mr. A seems to turn the lighting OFF and go to bed, but the room temperature seems to be high. I'm worried about Mr. A's physical condition”, for example, and it is possible to take an appropriate response for the first user A.

As described above, the device system of the second embodiment can be applied to a monitoring service for a user using common home appliances. In addition, the device system of the second embodiment can be applied to a maintenance support service for home appliances. For example, when a home appliance breaks down, the user often performs different usage from normal usage, such as repeatedly pressing the power ON/OFF button or pressing the same button many times. Specifically, when an air conditioner is out of order, the air conditioner cooling power ON button and OFF button may be repeatedly pressed, or the heating power may be turned ON, even though the room temperature is 35° C.

When the device control apparatus 100A transmits a device control signal and the detection information of the different usage from the normal usage described above to the server apparatus 600, the server apparatus 600 can determine that the air conditioner has failed, and transmit the determination result to a support center or the like of the home appliance. By referring to the information transmitted, a worker of the support center can determine the abnormality of the air conditioner and promptly visit the user to repair the air conditioner.

As other specific examples of the device control apparatus 100A, for example, the following application examples are given.

For example, the device control apparatus 100A can transmit user's preference information to the server apparatus 600. Specifically, the device control apparatus 100A acquires the room temperature when the power button of the device 303 is turned “ON” from the temperature sensor of the sensor apparatus 500, and transmits the room temperature to the server apparatus 600. As a result, the server apparatus 600 can collect information that the user of the device 303 often turns the cooling function “ON” when the room temperature is 29 degrees, for example. On the basis of the collection result of the server apparatus 600, the device control apparatus 100A can implement a function of automatically turning “ON” the cooling function when information that the room temperature of 28.7 degrees is detected is acquired from the sensor apparatus 500, as an extended function.

In addition, when the power button of the device (TV) 301 is turned “ON”, the device control apparatus 100A acquires, at predetermined intervals, channel information of the channel viewed by the user, volume of user's cheer or laughter collected by the microphone of the sensor apparatus 500, and volume of the sound output from the speaker of the device 301, and transmits them to the server apparatus 600. As a result, the server apparatus 600 can collect information for grasping a relationship among the program content, the volume of the user's voice, and the volume of the TV. That is, the server apparatus 600 can store not only audience rating information of a TV program but also qualitative parameters of the TV program additionally. As a result, producers of TV programs can receive information useful for making programs from the information provided from the server apparatus 600.

Note that, the device control apparatus 100A may be configured to store information to be transmitted to the server apparatus 600 in a storage area (not illustrated) in the apparatus, and refer to the stored information.

As described above, the device control apparatus 100A according to the second embodiment includes the detection information acquiring unit 109 for acquiring the information detected by the sensor apparatus 500 as the detection information, and the transmission information generating unit 110 for generating the transmission information to be transmitted to the server apparatus 600 on the basis of the acquired detection information.

As a result, using a common device remote controller, it is possible to provide a function that is a new function not supported by a device and useful for users, corresponding to operation of the device remote controller, and transmit the information based on the detection information to an external apparatus. Further, information on the basis of the device control signal or the execution result of the extended function can be transmitted to the external apparatus.

Note that, in the first embodiment and the second embodiment described above, an example case is described where one button of the device remote controller 200 is pressed. On the other hand, when a plurality of buttons of the device remote controller 200 is pressed, the configuration may be adopted in which a control program associated with the pressed buttons and the order in which the buttons are pressed are acquired, whereby the device 300 is controlled. In this case, the signal acquiring unit 102 temporarily stores the acquired device control signal in a storage area (not illustrated) such as a buffer, and input the device control signal accumulated for a certain period of time to the collation unit 104. The collation unit 104 performs collation of the device control signal database 106 on the basis of a combination of the device control signals and a reception order of the device control signals, and acquires program identification information. For example, when meaning is given to the reception order of a plurality of device control signals, and buttons of the device remote controller 200 of the device 301 are pressed continuously in the order of “Ch1”, “Ch2”, “Ch3” in 5 seconds, the collation unit 104 acquires program information for executing processing of changing displays in a short time, like thereafter “Ch4”, “Ch5”, . . . .

As a result, the device control apparatuses 100 and 100A can perform control to execute an extended function corresponding to the combination of the plurality of device control signals and the reception order.

Besides the above, in the present invention, within the scope of the invention, free combination of each embodiment, a modification of any component of each embodiment, or omission of any component of each embodiment is possible.

### INDUSTRIAL APPLICABILITY

The device control apparatus according to the present invention can be used in a system or the like for providing a new function regarding a device by using a common device remote controller, in addition to operating the device by using the common device remote controller.

### REFERENCE SIGNS LIST

100, 100A: Device control apparatus, 101: Reception unit, 102: Signal acquiring unit, 103: Extended function determining unit, 104: Collation unit, 105: Control program acquiring unit, 106: Device control signal database, 107: Extended function database, 108: Output control unit, 109: Detection information acquiring unit, 110: Transmission information generating unit, 111: Transmission unit.

1. A device control apparatus comprising processing circuitry
to acquire, by a signal acquirer, a device control signal that is transmitted from a device remote controller and used to control a device;
to acquire, by an extended function determinator, a control program for executing an extended function for extending a function of the device that corresponds to the device control signal and is not supported by the device by collating the device control signal acquired by the signal acquirer with accumulated information; and
to control, by an output controller, a corresponding output apparatus by executing the control program acquired by the extended function determinator.

2. The device control apparatus according to claim 1, wherein the processing circuitry is configured
to acquire, by a detection information acquirer, information detected by a sensor apparatus as detection information; and
to generate, by a transmission information generator, transmission information to be transmitted to an external apparatus on a basis of the detection information acquired by the detection information acquirer.

3. The device control apparatus according to claim 2, wherein the transmission information generator generates the transmission information on a basis of the device control signal or the control program executed by the output controller.

4. The device control apparatus according to claim 1, wherein the extended function determinator acquires the control program by performing collation with the accumulated information by using information of time at which the signal acquirer acquired the device control signal in addition to the device control signal.

5. The device control apparatus according to claim 1, wherein the extended function determinator acquires the control program by performing collation with the accumulated information by using detection information that is information detected by a sensor apparatus in addition to the device control signal.

6. The device control apparatus according to claim 1, wherein the device control signal includes a plurality of device control signals for controlling the device, and
the extended function determinator performs collation with the accumulated information on a basis of a combination of the plurality of device control signals and a reception order of the plurality of device control signals.

7. A device control method comprising:
acquiring, by a signal acquirer, a device control signal that is transmitted from a device remote controller and used to control a device;
acquiring, by an extended function determinator, a control program for executing an extended function for extending a function of the device that corresponds to the device control signal and is not supported by the device by collating the device control signal acquired with accumulated information; and
controlling, by an output controller, a corresponding output apparatus by executing the control program acquired.

8. A device control program for causing a computer to execute:
acquiring a device control signal that is transmitted from a device remote controller and used to control a device;
acquiring a control program for executing an extended function for extending a function of the device that corresponds to the device control signal and is not supported by the device by collating the device control signal acquired with accumulated information; and
controlling a corresponding output apparatus by executing the control program acquired.
